(19) United States
(12) Patent Application Publication
(10) Pub. No.: US 2005/0267388 A1
(43) Pub. Date: Dec. 1, 2005

(54) Method and apparatus for relief of headache

(76) Inventor: Joseph P. Hanna, Brecksville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/137,239

(22) Filed: May 25, 2005

Related U.S. Application Data
(60) Provisional application No. 60/574,543, filed on May 26, 2004.

(51) Int. Cl. A61H 1/00

(52) U.S. Cl. 601/70; 601/79; 601/46

(57) ABSTRACT

A non-pharmaceutical apparatus for relieving pain that that is not invasive, does not require medical personnel to administer, and does not cause pain, is provided. The apparatus comprises: a vibration system comprising a vibration generator; at least one power source, to provide power to the vibration generator; optionally an amplitude control device which controls the amplitude of the vibration; optionally a frequency control device which controls the frequency of vibration; and a head-piece adapted to fit the patient's head, which holds at least one component of the vibration system against the patient's head. The vibration system further comprises: optionally a vibrating which receives vibrations from the vibration generator and transmits them to the patient's head. Optionally, the pain relieving apparatus further comprises a microprocessor or any control and a memory device. A method of relieving headache pain in a patient is also provided.

### BACKGROUND OF THE INVENTION

People have sought relief from headache pain for centuries. While many pharmaceutical compositions have proved quite successful, many are not strong enough to relieve severe pain. Also, continued use of many medications leads to adverse side effects. Narcotic pharmaceuticals impair patient functioning and can be addictive.

Moreover, many patients are not suitable candidates for pharmaceutical intervention. Pregnant women are advised to avoid most medications. Patients with atherosclerosis are prohibited from taking many migraine relieving pharmaceuticals. Patients on other medications for other medical conditions suffer drug interactions. Many medications must be ingested, which can be quite problematic for people with difficulty swallowing.

While non-pharmaceutical methods of relieving headache pain have been explored, they suffer from additional drawbacks. Percutaneous electrical nerve stimulation, often abbreviated as PENS, has been used to treat headache pain. However, percutaneous electrical nerve stimulation requires the insertion of needles into the patient's temple and the administration of electricity. Percutaneous electrical nerve stimulation is invasive, requires medical personnel to administer, and can stimulate pain fibers and cause pain both at the site of application and within the region of the nerve being stimulated.

It would be desirable to have a non-pharmaceutical apparatus for relieving headache pain that is not invasive, does not require medical personnel to administer, and does not cause pain.

### SUMMARY OF THE INVENTION

The present invention relates to a non-pharmaceutical apparatus for relieving and preventing headache pain that that is not invasive, does not require medical personnel to administer, and does not cause pain.

The pain relieving apparatus comprises: a vibration system comprising a vibration generator; at least one power source, to provide power to the vibration generator; optionally at least one amplitude control device which controls the amplitude of the vibration; optionally at least one frequency control device which controls the frequency of vibration; and a head-piece to be affixed to the patient's head, which holds at least one component of the vibration system against the patient's head. The vibration system comprises: at least one vibration generator which is either in contact with the head or not in contact with the head. Where the vibration generator is not in contact with the head, then the vibration system further comprises at least one vibrating plate which receives vibrations from the vibration generator and transmits them to the patient's head. Optionally, the pain relieving apparatus further comprises a microprocessor or any control device that can pattern or vary the amplitude or the frequency, according to a program, or as desired by the patient. Optionally, the pain relieving apparatus further comprises a memory device for recording all or some of the following: time, duration, frequency, amplitude, position of vibrating plate and/or position of vibration generator, for review or diagnosis.

The invention also relates to a method of relieving headache pain in a patient, comprising the following steps: transmitting vibrations to the patient's head. The method further comprises the step of ceasing transmitting vibrations to the patient's head.

### BRIEF DESCRIPTION OF THE INVENTION

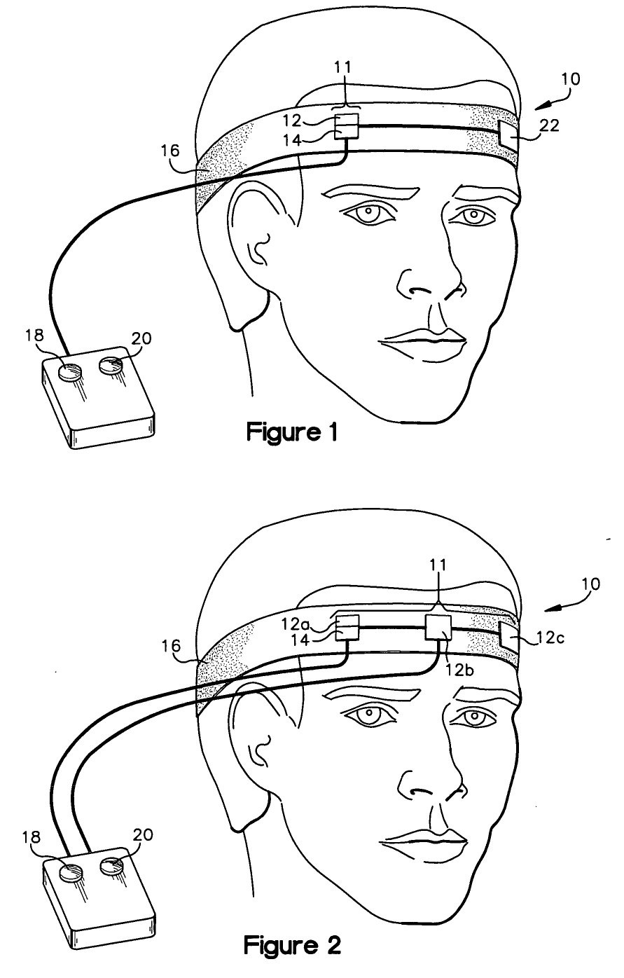

FIG. 1 shows an embodiment of the pain relieving apparatus having a vibration generator disposed in the head-piece which is fitted on a patient's head;

FIG. 2 shows an embodiment of the pain relieving apparatus having multiple vibration generators disposed in the head-piece which is fitted on a patient's head;

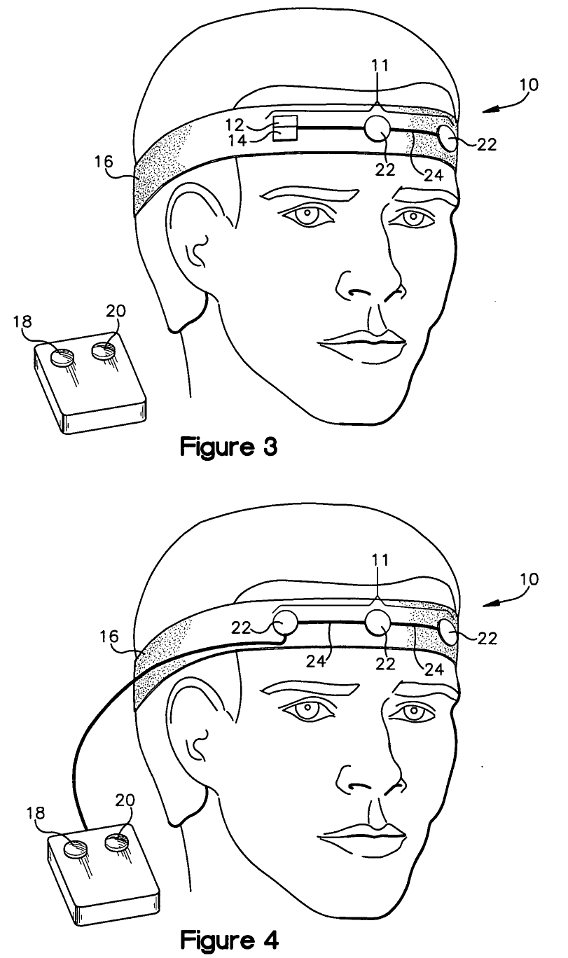

FIG. 3 shows an embodiment of the pain relieving apparatus having a vibration generator and vibration plates disposed in the head-piece which is fitted on a patient's head, and

FIG. 4 shows an embodiment of the pain relieving apparatus having a vibration plate, disposed in the head-piece which is fitted on a patient's head, vibration generator is not disposed in or on the head-piece;

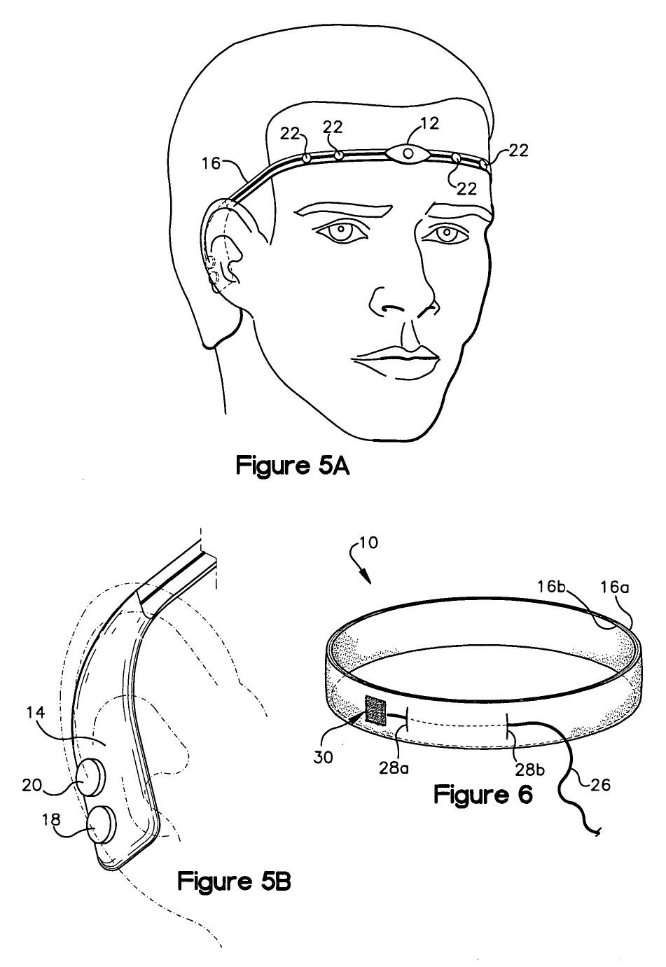

FIG. 5a shows another embodiment of the pain relieving apparatus having a vibration plate, and a vibration generator disposed in the head-piece which is adapted to fit over the patient's ear, with the power source, amplitude and frequency control in a pack attached to the earpiece of the head-piece;

FIG. 5b is a close up view of the pack shown in FIG. 5a, with the power source, amplitude and frequency control disposed in the pack; and

FIG. 6 shows an embodiment of the pain relieving apparatus having a vibration plate, without a vibration generator disposed in the head-piece, which is adapted to fit on a patient's head.

### DETAILED DESCRIPTION OF THE INVENTION

The present invention relates to a non-pharmaceutical apparatus for relieving and preventing chronic and intermittent headache pain that that is not invasive, does not require medical personnel to administer, and does not cause pain. The frequency of occurrence of headaches may also be reduced.

The apparatus comprises: a vibration system; at least one power source, to provide power to the vibration generator; preferably at least one amplitude control device which controls the amplitude of the vibration; preferably at least one frequency control device which controls the frequency of vibration; and a head-piece to be affixed to the patient's head, which holds at least one component of the vibration system against the patient's head. The vibration system comprises: at least one vibration generator which is either in contact with the head or not in contact with the head. Where the vibration generator is not in contact with the head, then the vibrations system further comprises at least one vibrating plate which receives vibrations from the vibration generator and transmits them to the patient's head. The pain relieving apparatus, particularly the vibration system, does not penetrate the skin.

The invention also relates to a method of relieving headache pain in a patient, comprising the following steps: transmitting vibrations to the patient's head. The method further comprises the step of ceasing transmitting vibrations to the patient's head.

Referring to FIG. 1, the pain relieving apparatus 10 comprises: a vibration system 11, a power source 14, to provide power to the vibration system 11; an amplitude control device 18 which controls the amplitude of the vibration; a frequency control device 20 which controls the frequency of vibration; and a head-piece 16 adapted to fit the patient's head H, which holds at least one component of the vibration system 11 against the patient's head. The vibration system 11 comprises: at least one vibration generator 12, and optionally at least one vibrating plate 22 connected to the vibration generator 12 which receives vibrations from the vibration generator 12 and transmits them to the patient's head.

In another embodiment, as shown in FIG. 2, more than one vibration generator 12 is employed, preferably at spaced apart locations on the patient's head. As shown in FIG. 2, vibration generator 12a, vibration generator 12b and vibration generator 12c are positioned in or on head-piece 16.

In another embodiment, as shown in FIG. 3, one or more vibrating plates 22 are employed at spaced apart locations in the head-piece 16. Optionally, conventional connecting devices 24 are used to connect the vibration generator 12 to the vibration plate 22, and thus to transmit the vibrations from the vibration generator 12 to the vibrating plate 22.

In another embodiment, as shown in FIG. 4, the vibration system comprises a vibration plate 22 disposed in the head-piece 16 which is fitted on a patient's head. The vibration generator 12 is disposed in pocket p and connected by wire 26 to plate 22.

FIG. 5a shows another embodiment of the pain relieving apparatus 10, having a vibration plate 22, and a vibration generator 12 disposed on the head-piece 16 which is adapted to fit over the patient's ear E, with the power source, amplitude and frequency control in a pack attached to the earpiece of the head-piece. FIG. 5b is a close up view of the pack shown in FIG. 5a, with the power source 14, amplitude control 18 and frequency control 20 disposed in the pack.

Referring to FIG. 6, which shows another embodiment of the pain relieving apparatus 10, having head-piece 16 which comprises an elastic terrycloth outer band 16a and an inner band 16b, which inner band 16b is annularly disposed in outer band 16a, a first hole 28a, a second hole 28b, and an area of hook tape 30 for attaching vibrating plate 22 (not shown). The apparatus also has a wire 26 for connecting to vibrating plate 22 (not shown), which wire is threaded into hole 28a and runs between inner band 16b and outer band 16a and emerges through hole 28b which is typically positioned near the patient's ear. The wire 26 runs down to the vibration generator 12 which is disposed on the patients clothing such as a pocket, waistband or belt.

The Vibration System

The vibration system 11 comprise at least one vibration generator 12. Preferably, the vibration generator 12 is capable of producing vibrations over a range of frequencies, preferably from 5 to 1000 hertz, more preferably from 10 to 750 hertz, even more preferably from 25 to 500 hertz, most preferably from 50 to 350 hertz. While a vibration generator 12 that produces vibration at one frequency is also suitable, it is less preferred. A comfortable frequency/wavelength is 150-200 hz. The vibration generator is preferably a piezoelectric device, which preferably vibrates between 25 and 500 Hertz.

Optionally, the vibration generator 12 is capable of producing vibration over a range of amplitude, so that the amplitude may be adjusted by the patient, preferably from 0 to 5 mm, more preferably from 0.005 mm to 5 mm, more preferably from 0.01 to 2 mm, even more preferably from 0.01 to 1 mm, more preferably from 0.05 to 0.5 mm.

Suitable vibration generators are known and commercially available; for example, they may be devices that produce vibrations through oscillation or wave-form generators. Vibration generators such as used in personal pagers carried by medical personnel are suitable. Piezoelectric vibration generators and MEMS vibration generators have the advantages of compact size and low power requirements. A suitable vibration generator is a piezoelectric device, which vibrates between 25 and 500 Hertz.

Conventional wave-form generators are suitable as a vibration generator; a suitable wave-form generator is available under the designation 4010A 2 Mz function generator, from B+K Corporation, Yorba Linda, Calif. Where a wave-form generator is employed, different wave forms are used to produce the vibrations: sinusoidal wave-form, square wave and the like.

The vibration generator 12 is either in contact with the head, directly or indirectly, or it is not in contact with the head and is disposed away from the head. Where the vibration generator 12 is in direct contact with head, it is touching the patient's skin or hair. Where the vibration generator 12 is in indirect contact with head, it is typically touching material, typically part of the head-piece.

Vibrating plates 22 receive vibrations from the vibration generator 12, and transmit them to the patient's head, but the vibrating plates do not otherwise generate vibrations. The shape and composition of the vibrating plate 22 is not crucial. By employing vibrating plates, one can provide multiple vibration sources against the patient's head without the need for multiple vibration generators.

Vibrating plates are optional, although where the vibration generator 12, is not in contact with the head, they are highly preferred.

The vibrating plate 22 is conventional, a suitable vibrating plates are a microphone, a skin transducer. A suitable skin transducer is available under the designation Model VBW32 from Audiological Engineering Corp, Somerville, Mass. The Model VBW32 skin transducer which has a hook fastener on the back, has the following specifications: 1 inch by 0.73 inches by 0.42 inches thick; weighs 6.5 grams; a coil resistance of 32 ohms, a 250 Hz nominal peak frequency; with a usable output at reduced levels of 100 Hz to 800 Hz; an amplitude range from sensory threshold to 50 dB above threshold; a transient response time of 5 milliseconds; a 200 milliwatts power consumption and a nominal voltage drive of 2.5 volts rms.

Optionally, conventional connecting devices 24 are used to connect the vibration generator 12 to the vibration plate 22, and thus to transmit the vibrations from the vibration generator 12 to the vibrating plate 22. For example, a rod, which vibrates in response to the vibration generator, is optionally used to transmit vibrations from the vibration generator to the vibrating plates. Alternatively, a wire is employed, which carries an electrical signal from the vibrating generator to the vibrating plate which produces vibrations. In an alternative embodiment, a wireless system is employed in which a receiver in the vibrating plate receives a signal transmitted through the air, from the vibration generator.

The Power Source

The power source 14 providing electrical power to the device may be any conventional power source, such as, a conventional AC power line or alternatively may be battery or solar operated, as may be necessary for providing an ambulatory unit. The device is optionally operated using 110 or 120 V electrical power. Where batteries are used, lithium ion batteries which are rechargeable for providing a portable device are suitable. Optionally, the power source is disposed in or on the vibration generator or in or on the head-piece.

The Head-Piece

The head-piece 16 is adapted to fit the patient's head and is optionally made of material sufficient to support the weight of the vibration system. In one embodiment, the head-piece is a band of a length to encircle a patient's head. In an alternative embodiment, the head-piece is supported by the patient's ears. In another embodiment, the head-piece is equipped with adhesive material for affixing the head-piece to the patient's head. In an alternative embodiment, the head-piece is in a form such as a hat or cap which is adapted to fit over the patient's head. The head-piece is optionally adjustable to the patient's head using conventional fasteners such as for example, snaps, a buckle, hook fasteners, such as those available under the trademark Velcro®, strings for tying, or by elastic and the like.

A suitable head-piece is made from a commercially available head band of cloth, for example terricloth, available from Unique Sports Products, Alpharetta, Ga. Optionally, the head band comprises an inner band made from fabric, such as those available from Scunci International, formerly L&N Sales and Marketing, Hatboro, Pa. The two bands are fastened together by conventional methods, such as by adhesives, fasteners, or sewing.

Optionally, two holes are formed in the head-piece to accommodate a wire that runs from the vibration generator to the vibrating plate.

At least one vibration source is disposed on or in the head-piece. The vibration source is either one or more vibration generators 12 or one or more vibrating plates 22 or a combination of one or more vibration generators and one or more vibrating plates. The vibration generators and vibrating plates may be fixed to the head-piece or disposed on the head-piece in such a manner that their positions may be changed.

Preferably, at least one vibration generator 12 is disposed on or in the head-piece using conventional techniques and devices. For example, the vibration generator is located: within the material of the head-piece; in a pocket created in the head-piece; or attached to the head-piece using conventional fasteners such as for example, snaps, screws, rivets, buckles, clips, hook fasteners such as available under the trademark Velcro®. Preferably, the vibration generator is affixed to one location on the head-piece; alternatively the vibration generator is variably affixed to permit the position of the vibration generator to be easily changed.

In an alternate embodiment, the vibration generator 12 is not on the head-piece 16, but disposed elsewhere such as a pocket of the patient's clothing. Where the vibration generator 12 is not disposed on or in the head-piece, then at least one vibrating plate 22 is employed to provide a vibration source, and such vibrating plate is disposed in or on the head-piece 16, using conventional techniques and devices. For example, the vibrating plate may be located within the material of the head-piece, in a pocket created in the head-piece, or attached to the head-piece using conventional fasteners such as for example, snaps, screws, rivets, buckles, clips, hook fasteners such as available under the trademark Velcro®. Preferably, the vibrating plate is affixed to one location on the head-piece; alternatively the is variably affixed to permit the position of the vibrating plate to be changed.

The power source is preferably disposed on or in the head-piece using conventional techniques and devices. For example, the power source is preferably located: within the material of the head-piece; in a pocket created in the head-piece; or attached to the head-piece using conventional fasteners such as for example, snaps, buckles, hook fasteners such as available under the trademark Velcro®.

Preferably, the power source is affixed to one location on the head-piece; alternatively the power source is variably affixed to permit the position of the power source to be changed.

Alternatively, the power source may be physically separate from the head-piece or the vibration generator, and connected by wires, although such an arrangement is cumbersome and less preferred.

Amplitude Control Device and Frequency Control Device

Optionally, the apparatus further comprises an amplitude control device 18 which controls the amplitude of the vibration. The amplitude control device 18 is conventional.

Optionally, the apparatus also comprises a frequency control device 20 which controls the frequency of vibration. Optionally, the amplitude control device 18 and frequency control device 20 are contained in a single unit for ease of use. The frequency control device 20 is conventional.

The amplitude control device 18 and frequency control device 20 are optionally disposed in or on the head-piece, or, separate from the head-piece. For example, the amplitude control device 18 and frequency control device 20 are a hand-held device or a device adapted to attach to the patient or to the patient's clothing; for example, to fit in a pocket or adapted to clip onto a belt. The amplitude control device 18 and frequency control device 20 are electrically connected to either or both the vibration generator and the vibrating plate; the connection itself is by an electrically conducting wire or wireless.

Other Features

Optionally, the pain relieving apparatus further comprises a microprocessor that can pattern or vary the amplitude or the frequency, according to a program, or as desired by the patient. Optionally, the pain relieving apparatus further comprises a memory device for recording time, duration, frequency, amplitude, position of vibrating plate and/or position of vibration generator, for review or diagnosis.

### Method for Relieving Headaches

Patients suffering from chronic or intermittent headaches, for example migraine, tension, or post traumatic headaches can have headache lessened or in some instances completely relieved, and in other instances prevented, by applying at least one vibration source to the head, preferably near the region of maximal pain. Typically; the vibration source will be placed on the forehead, or on a region near the point of maximal pain.

In the method of the present invention, it is possible for the patient to place their head against a vibration source. However, it is preferable that the vibration source be placed against the patient's head or on the patient's body to permit the patient to move freely.

While the vibration source can be held in place by the medical personnel or the patient himself, it is preferred that the pain relieving apparatus 10 of the present invention be employed. The pain relieving apparatus 10, which holds at least one component of the vibration system 11 in place against the patient's head, leaves the patient's hands free.

The method of relieving headache pain in a patient comprises the following steps: transmitting vibrations to the patient's head. The method further comprises the step of ceasing transmitting vibrations to the patient's head. Optionally, the method further comprises the step of adjusting an amplitude control to obtain the maximum pain relief. Optionally, the method further comprises the step of adjusting a frequency control to obtain the maximum pain relief. Typically, the vibration source is placed against the patient's head for about 15 to 30 minutes, although the exact time will vary depending on the patient and the severity of the headache. Severe headaches may require that the vibrations be transmitted to the person's head for several hours.

Preferably, the apparatus of the present invention is employed in the method for treating headache pain.

The vibration source is a device that is vibrating against the patient's head to relieve the headache. The vibration source is optionally the vibration generator 12, although as seen in alternate embodiments, the vibration source may also be a vibrating plate 22, which receives vibrations from the vibration generator 12, and transmits them to the patient's head. Preferably the headache relieving apparatus 10 is employed to relieve headache pain.

The method and apparatus of the present invention are useful for relieving pain in the primary headaches, for example: migraine, tension-type headache, cluster headache and other primary headaches; and the secondary headaches: headaches attributed to head and/or neck trauma, cranial or cervical vascular disorder, non-vascular intracranial disorder, a substance or its withdrawal, infection, disorder of homeostasis, headache pain attributed to disorder of cranium, neck and/or cranial structures, psychiatric disorder, cranial neuralgias, other headaches.

### EXAMPLES

### Example 1

A vibration generator, having a piezoelectric vibration generator, was placed against the temple of a patient suffering from a migraine headache for about 30 minutes. The vibration generator emitted vibrations at 200 hertz. After the 30 minutes the patient reported that the pain was lessened.

### Example 2

A vibration generator was placed against the temple of a patient suffering from a migraine headache for about 30 minutes. The vibration generator emitted vibrations at 200 hertz. After the 30 minutes the patient reported the pain was lessened.

### Example 3

A vibration generator was placed against the temple of a patient suffering from a tension headache for about 30 minutes. The vibration generator emitted vibrations at 200 hertz. After the 30 minutes the patient reported that the pain was lessened.

### Example 4

A study of the comfort of various frequencies was conducted by placing the apparatus shown in FIG. 6, on male and female asymptomatic test subjects of varying ages. The vibrating plate, a skin transducer, Model VBW32 from Audiological Engineering Corp, Somerville, Mass., was attached to the hook tape on the head-piece. The waveform generator was a 4010A 2 Mz function generator, from B+K Corporation, Yorba Linda, Calif. The frequencies listed in the table are the frequency settings on the wave form generator. The results are shown in Table II.

TABLE II

| Sub. | Age | Gen. | Mig. | 50 Hz | 100 | 150 | 200 | 250 | 300 | 350 | 400 | 600 |
|---|---|---|---|---|---|---|---|---|---|---|---|---|
| 1 | 43 | M | Y | C | C | C | C | C | U | A | A | A |
| 2 | 41 | F | Y | C | C | C | C | C | U | A | A | A |
| 3 | 8 | M | N | C | C | C | C | U | U | A | A | |
| 4 | 10 | F | Y | C | C | C | C | U | U | A | A | |
| 5 | 41 | F | N | C | C | C | C | U | A | A | | |
| 6 | 52 | F | N | C | C | C | C | C | U | A | A | |
| 7 | 54 | F | Y | C | C | C | C | C | U | A | A | |
| 8 | 48 | F | Y | C | C | C | C | U | A | A | | |
| 9 | 45 | M | Y | C | C | C | C | C | U | A | A | |
| 10 | 35 | F | N | C | C | C | C | U | U | A | A | |

C - comfortable at 5 minutes
U - mildly uncomfortable; stimulus tolerable but some discomfort before 5 minutes
A - annoying, uncomfortable from onset

1. An apparatus for relieving headache pain in a patient, comprising:
a. a vibration system, comprising at least one vibration generator which generates vibrations;
b. a power source, to provide power to the vibration generator; and
c. a head-piece, adapted to fit the patient's head, which holds at least one component of the vibration system against the patient's head.

2. The apparatus of claim 1, wherein the vibration generator is not disposed in or on the head-piece.

3. The apparatus of claim 1, wherein the vibration generator is disposed in or on the head-piece.

4. The apparatus of claim 2, further comprising: an amplitude control device which controls the amplitude of the vibrations, and a frequency control device which controls the frequency of vibrations.

5. The apparatus of claim 3, further comprising: an amplitude control device which controls the amplitude of the vibrations, and a frequency control device which controls the frequency of vibrations.

6. The apparatus of claim 1, wherein the vibration generator generates vibrations having a frequency of between from 5 to 1000 hertz.

7. The apparatus of claim 1, wherein the vibration generator generates vibrations having a frequency of between from 25 to 100 hertz.

8. The apparatus of claim 1, wherein the pain relieving apparatus further comprises a microprocessor.

9. The apparatus of claim 2, wherein the vibration system further comprises a plurality of vibrating plates.

10. The apparatus of claim 3, wherein the vibration system further comprises a plurality of vibrating plates.

11. An apparatus for relieving headache pain in a patient, comprising:
a. a vibration system, comprising at least one vibration generator which generates vibrations in the frequency range of from 5 hertz to 1000 hertz and at least one vibrating plate;
b. a power source, to provide power to the vibration generator; and
c. a head-piece, adapted to fit to the patient's head, which holds at least one vibrating plating against the patient's head;
d. an amplitude control device which controls the amplitude of the vibrations;
e. a frequency control device which controls the frequency of vibrations.

12. The apparatus of claim 11, wherein the vibration generator is not disposed in or on the head-piece.

13. The apparatus of claim 11, wherein the vibration generator is disposed in or on the head-piece.

14. The apparatus of claim 11, wherein the vibration generator generates vibrations having a frequency of between from 10 to 750 hertz.

15. The apparatus of claim 11, wherein the vibration generator generates vibrations having a frequency of between from 50 to 350 hertz.

16. The apparatus of claim 11, wherein the pain relieving apparatus further comprises: a microprocessor; and a memory device.

17. A method of relieving headache pain in a patient, comprising the following steps:
a. transmitting vibrations to the patient's head for a sufficient time to relieve the headache pain.

18. The method of claim 17, further comprising the step of ceasing transmitting vibrations to the patient's head.

19. The method of claim 17, wherein the vibrations are transmitted to the patient's head using a apparatus for relieving headache pain, said apparatus comprising:
a. a vibration system, comprising at least one vibration generator which generates vibrations;
b. a power source, to provide power to the vibration generator; and
c. a head-piece adapted to fit the patient's head, which holds at least one component of the vibration system against the patient's head.

20. The method of claim 17, wherein the vibration generator generates vibrations having a frequency of between from 50 to 350 hertz.
